(19) United States
(12) Patent Application Publication
(10) Pub. No.: US 2005/0022069 A1
(43) Pub. Date: Jan. 27, 2005

(54) Methods, systems and computer program products for correcting errors in service orders

(76) Inventor: Duane Firman, Titusville, FL (US)

Correspondence Address: MYERS BIGEL SIBLEY & SAJOVEC, PO BOX 37428, RALEIGH, NC, 27627, US

(21) Appl. No.: 10/624,160

(22) Filed: Jul. 21, 2003

(51) Int. Cl. G06F 11/00

(52) U.S. Cl. 714/46

(57) ABSTRACT

A service order comprises an electronic document having a plurality of fields, the plurality of fields having data associated therewith. Correcting an error in a service order includes providing a service order control panel. The service order control panel comprises a plurality of function controls. Each function control has an associated predetermined function that manipulates data in at least one of the plurality of fields in the service order. User input from a user is accepted to select a function control. The predetermined function associated with the selected function control is performed to manipulate data to correct the error in at least one of the plurality of fields in the service order.

### FIELD OF THE INVENTION

The present invention relates to user interfaces and function controls of a data processing system and, more particularly, to user interfaces and function controls for correcting errors in service orders on a data processing system.

### BACKGROUND OF THE INVENTION

Data processing systems are increasingly used in connection with providing various consumer services. For example, data processing systems can be used to process and maintain service orders in various industries including the telecommunications industry.

Telecommunications services have expanded in recent years to include a variety of relatively new service options. Telecommunications services can include features, such as voice mail, “call waiting” services to alert a user of a telephone line that a second call has been made, and caller identification services. Moreover, telecommunications customers have many options to subscribe to various services in addition to traditional telephone service. These services can include cable or DSL based access to the Internet, cable television, satellite television, wireless cellular phone services, and the like. Residential and/or commercial customers may have different requirements for customizing services.

The added complexity of the services offered may increase the need to automate orders for services using a data processing system. Typically, an order for a particular service is received by a service representative employed by a telecommunications company. The requests may be made by interactions with the service representative by phone, or the requests can be made may mail order, electronic mail, or through the Internet. The service order request is typically entered into an electronic service order document and electronically and/or manually processed. Once the order is complete, i.e., the service request has been performed, the service order can be stored in a processor memory or deleted from the data processing system.

Occasionally, service orders have irregularities or deficiencies that can be recognized by the data processing system. These orders cannot be granted a “complete” status without intervention. For example, some service orders can be completed electronically without requiring “field work”, i.e., a worker traveling to the customer site. However, the service order may erroneously indicate that field work is required. Other typical errors include mismatched dates, such as a service order indicating that service was performed on a date that is different from a requested service date. Orders with errors are typically compiled in a list of orders requiring some form of intervention. The list may include an error code to indicate the nature of the error. A service operator may need to access the order from the data processing system and manually change the order to correct the error. This process can be time consuming, labor intensive, and expensive for service industries such as the telecommunications industry.

### SUMMARY OF THE INVENTION

According to embodiments of the present invention, methods of correcting an error in a service order are provided. A service order comprises an electronic document having a plurality of fields, and the plurality of fields have data associated therewith. Correcting an error in a service order includes providing a service order control panel. The service order control panel includes a plurality of function controls. Each function control has an associated predetermined function that manipulates data in at least one of the plurality of fields in the service order. User input from a user is accepted to select a function control. The predetermined function associated with the selected function control is performed to manipulate data to correct the error in at least one of the plurality of fields in the service order.

While the invention has been described above primarily with respect to the method error correction aspects of the invention, both systems and/or computer program products are also provided.

### BRIEF DESCRIPTION OF THE DRAWINGS

FIG. 1 is a block diagram of a system according to embodiments of the present invention;

FIG. 2 is a block diagram of a data processing system according to embodiments of the present invention;

FIG. 3 is a more detailed block diagram of data processing systems according to embodiments of the present invention;

FIG. 4 is a flowchart illustrating operations of a service order control panel according to embodiments of the present invention;

FIG. 5 is a flowchart illustrating operations of a service order control panel according to further embodiments of the present invention; and

FIG. 6 is a block diagram illustrating fields of data in a service order according to embodiments of the present invention; and

FIG. 7 is a screen shot illustrating a service order control panel according to embodiments of the present invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by those of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to an embodiment of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

As is described in more detail below, the present invention provides for the correction of errors in a service order. The service order is an electronic document having various fields and data associated with the respective fields. A service order control panel is provided that includes function controls. Each function control has an associated predetermined function that manipulates data in at least one of the fields in the service order. Input can be accepted from a user to select a function control. The predetermined function associated with the selected function is then performed to correct an error in at least one of the fields in the service order. Moreover, the service order control panel can include linking controls that are associated with a portion of the service order. The user input to select a linking control can be accepted, and the portion of the service order associated with the selected linking control can be displayed. Accordingly, the number of keystrokes necessary to correct errors in the service order can be reduced. Errors may be corrected in potentially less time and at reduced expense.

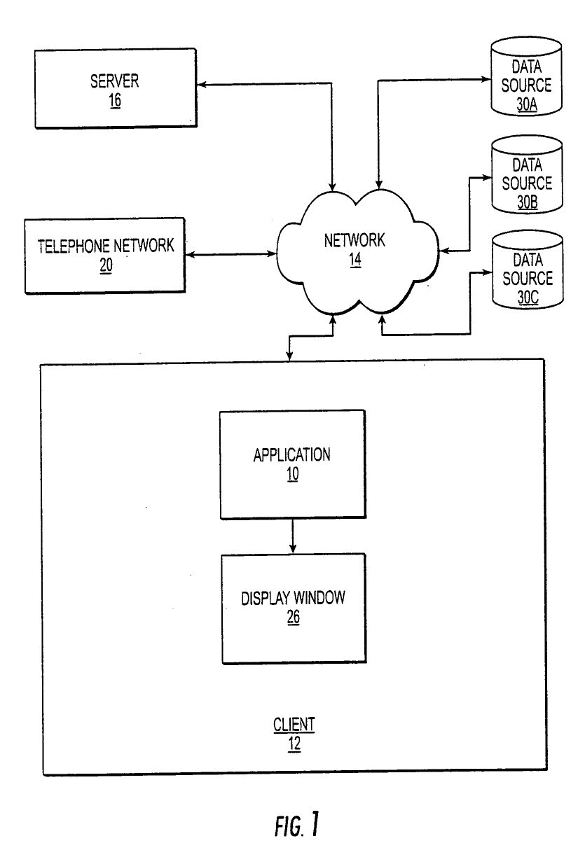

Various embodiments of the present invention will now be described with reference to FIGS. 1 through 7. FIG. 1 illustrates a network environment in which embodiments of the present invention may be utilized. As will be appreciated by those of skill in the art, however, the operations of embodiments of the present invention may be carried out on a single processing system with or without access to a network such as an intranet or the Internet. As seen in FIG. 1, a client data processing system 12, such as a personal computer or laptop computer, may utilize an application 10, such as a web browser or other application or program to communicate over network 14 to another data processing system which may act as a server 16. The application 10 can communicate with a display window 26 to display data. The network 14 may be an intranet or the Internet or other networks known to those of skill in the art.

As is further illustrated in FIG. 1, the server 16 can be in communication with data sources 30A, 30B, and 30C and a telephone network 20. The data sources 30A, 30B, and 30C can be computer servers, processing systems, or other networks that can send data to the client data processing system 12 over the network 14. The application 10 can display the data in the display window 26, which can be viewed and manipulated by the user. The application 10 can communicate with the telephone network 20, and the application 10 can carry out instructions to control services through the telephone network 20. For example, the application 10 can disconnect or connect services to a customer, such as features or services to a telephone or other communications device, by sending instructions to the telephone network 20.

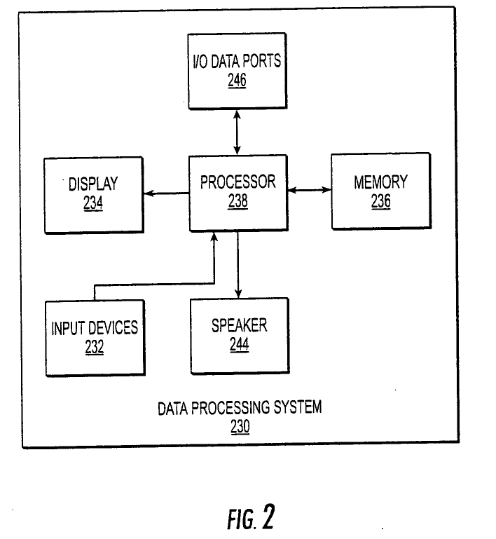

Referring to FIG. 2, exemplary embodiments of a data processing system 230 in accordance with embodiments of the present invention typically include input device(s) 232 such as a keyboard or keypad, touch sensitive screen, light sensitive screen, or mouse, a display 234, and a memory 236 that communicate with a processor 238. The data processing system 230 may further include a speaker 244, and an I/O data port(s) 246 that also communicates with the processor 238. The I/O data port 246 can be used to transfer information between the data processing system 230 and another computer system or a network (e.g., the Internet). These components may be conventional components such as those used in many conventional data processing systems which may be configured to operate as described herein. Furthermore, as will be appreciated by those of skill in the art, the data processing system 230 may be configured as the client 12 or the server 16.

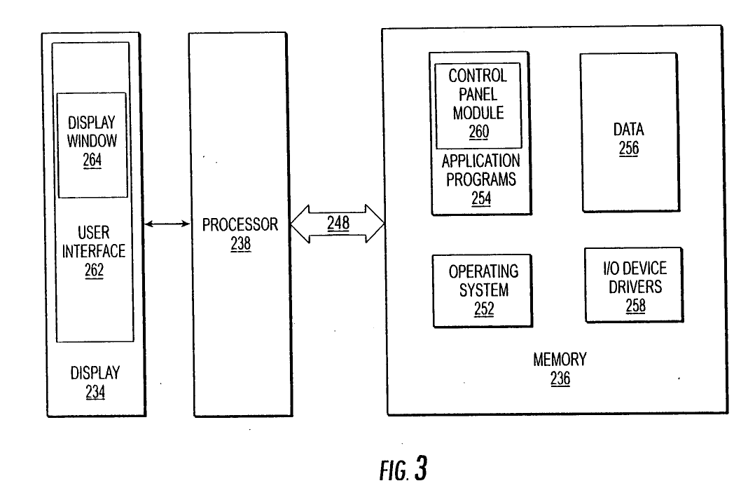

FIG. 3 is a block diagram of embodiments of data processing systems that illustrates systems, methods, and computer program products in accordance with the present invention: The processor 238 communicates with the memory 236 via an address/data bus 248. The processor 238 can be any commercially available or custom microprocessor. The memory 236 is representative of the overall hierarchy of memory devices containing the software and data used to implement the functionality of the data processing system 230. The memory 236 can include, but is not limited to, the following types of devices: cache, ROM, PROM, EPROM, EEPROM, flash memory, SRAM, and DRAM.

As shown in FIG. 3, the memory 236 may include several categories of software and data used in the data processing system 230: the operating system 252; the application programs 254; the input/output (I/O) device drivers 258; and the data 256. As will be appreciated by those of skill in the art, the operating system 252 may be any operating system suitable for use with a data processing system, such as OS/2, AIX or System390 from International Business Machines Corporation, Armonk, N.Y., Windows95, Windows98, Windows2000, or WindowsXP from Microsoft Corporation, Redmond, Wash., Unix or Linux. The I/O device drivers 258 typically include software routines accessed through the operating system 252 by the application program 254 to communicate with devices such as the input devices 232, the display 234, the speaker 244, the I/O data port(s) 246, and certain components of the memory 236. The display 234 includes a user interface 262 that displays data 256 with a display window 264. The application programs 254 are illustrative of the programs that implement the various features of the data processing system 230 and preferably include at least one application which provides the error correcting and/or data manipulation aspects of embodiments of the present invention. Finally, the data 256 represents the static and dynamic data used by the application programs 254, the operating system 252, the I/O device drivers 258, and other software programs that may reside in the memory 236. The data 256 can also be displayed in the display window 264.

As is further seen in FIG. 3, the application programs 254 preferably include a control panel module 260. The control panel module 260 preferably carries out operations as described herein for providing a service order control panel. Thus, the control panel module 260 may provide operations of one or more of the service order control functions to the data 256 and/or display 234.

While the present invention is illustrated, for example, with reference to a control panel module 260, as will be appreciated by those of skill in the art, the control panel module 260 may also be incorporated into other components, such as the operating system 252. Thus, the present invention should not be construed as limited to the configuration of FIG. 3 but is intended to encompass any configuration capable of carrying out the operations described herein.

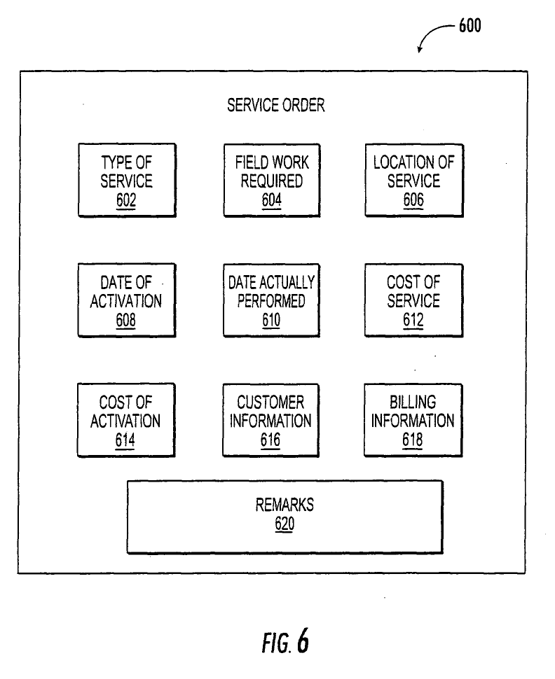

The data 256 preferably includes service orders. Service orders are electronic documents that include a plurality of fields having data associated therewith. An example of a service order 600 is shown in FIG. 6. The fields in the service order 600 can include the type of service requested 602, whether field work (i.e., a personnel visit to a service site) is required 604, the location of the service to be provided 606, the date of requested activation 608, the date that the activation was actually performed 610, the cost of the service 612, the cost of installation or activation 614, customer information 616, billing information 618, and/or miscellaneous remarks 620. The fields shown in the service order 600 can include additional fields or subfields. For example, the customer information 616 can include various informational fields such as address, consumer preferences, credit information and the like. The service orders typically have an identification number or code so that a user can access a service order by entering the respective identification code.

In certain embodiments, service orders with irregularities or errors requiring attention can be identified using software code that identifies errors in the data from the service orders. Software code can also assign an error code or identifier to the service order so that the operator knows why the service order has an error. For example, the error code can indicate which field requires attention or why the data indicates an error. Once a service order has been identified, the operator can determine if there is an error that requires correction.

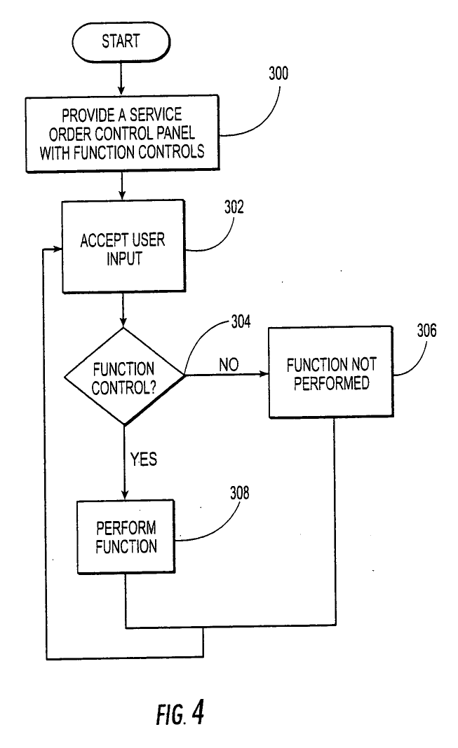

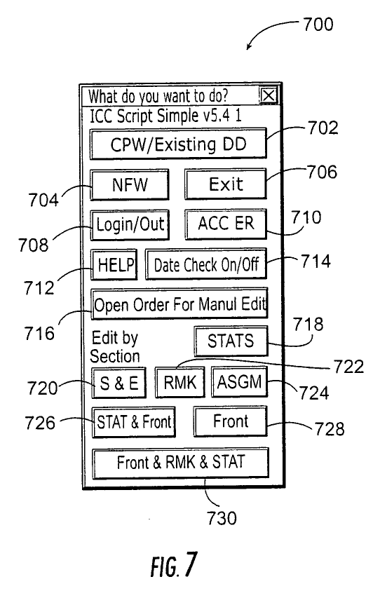

Embodiments of the present invention will now be described in more detail with reference to FIG. 4, which is a flowchart illustration of operations carried out by the control panel module 260. As seen in FIG. 4, the control panel module 260 may provide a service order control panel with function controls (block 300). An example of a service order control panel is shown in FIG. 7. Each of the function controls corresponds to a function that can be performed with respect to the service order. The functions can manipulate data in a field of the service order to correct an error.

The functions associated with the function controls identified in the control panel can include functions that alter data in a field in the service order to correct the error. The functions can also automatically change telecommunications services provided to a customer, such as activating the application 10 in FIG. 1 to instruct the telephone network 20 to connect or disconnect various services.

Referring to FIG. 4, the data processing system accepts user input (Block 302). The user input can be a selection of one of the function controls. The function control may be selected using various techniques such as a cursor selection made with a mouse, a keyboard selection, a physical selection on a touch-sensitive screen, activation of a light sensitive screen, laser activation, and other techniques known to those of skill in the art. If the user input is a selection of a function control (Block 304), the function is performed by the data processing system (Block 308) to correct an error. If the user does not select a function control (Block 304), then the function is not performed (Block 306).

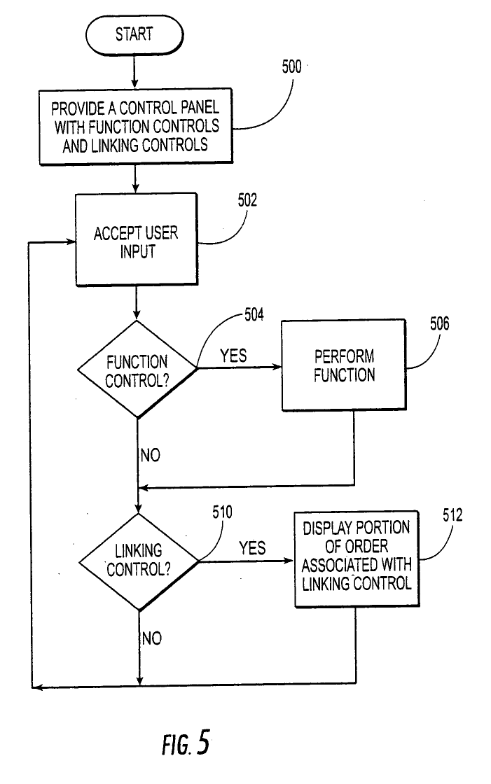

FIG. 5 illustrates operations according to further embodiments of the present invention where linking controls are provided. A control panel having function controls and linking controls is provided (Block 500). User input can be accepted (Block 502), and if the user input is a function control (Block 504), the selected function is performed (Block 506). If the user input is a linking control (Block 510), then the portion of the order associated with a linking control is displayed (Block 512). For example, a linking control can correspond to a particular field in the service order, such as the fields shown in FIG. 6. As shown in FIG. 5, when the linking control is selected (Block 510), the portion of the order including the field corresponding to the linking control can be displayed (Block 512). Accordingly, a user can edit the field corresponding to a linking control without requiring numerous keystrokes to locate the field within the service order.

The following are examples of functions that can be performed according to embodiments of the present invention: a “disconnect” function can automatically disconnect a telecommunications service and/or change the appropriate field in the service order to indicate that the disconnection has been performed; a “connect” function can automatically connect a telecommunications service and/or change the appropriate field to indicate that the connection has been performed; a “transfer” function can automatically transfer a telecommunications service to a predetermined location and/or change the appropriate field to indicate that the transfer has been performed; a “no field work” function can change one of the fields to indicate that no field work is required; a “complete” function can manipulate the data in one of the fields to indicate that the service order is complete; and a “date” function can change the data in a field to correct a mismatched date. Other functions may also be provided.

An exemplary control panel 700 is shown according to embodiments of the present invention is shown in FIG. 7. The control panel 700 includes a Complete Order With Existing Due Date key 702. If a user selects the Complete Order With Existing Due Date key, software code is initiated that performs a function to alter the fields in the service order to complete the order with its existing due date notwithstanding any inconsistencies in the due date and other dates in the order. Selection of the No Field Work key 704 initiates a function that changes fields in the service order to indicate that no field work is required to complete the order. Selection of the No Field Work key 704 may also initiate electronic functions to disconnect or connect telecommunications service to a customer prior to completing an order. The Exit key 706 allows the user to exit the program. The Login/Out key 708 allows the user to login or logout of the control panel 700. The Access Error key 710 corrects and completes orders that have access errors. Selection of the Help key 712 initiates a help menu for providing assistance to the user. Selection of the Date Check On/Off key 714 initiates a function that identifies errors in the dates on the service order. Selection of the Open Order For Manual Edit key 716 displays the service order and allows the user to manually edit the order.

The Status key 718, the Service & Equipment key 720, the Remarks key 722, the Assignment Section Central Office Switch key 724, the Status & Front key 726, the Front key 728, and the Front & Remarks & Status key 730 each display a portion of the service order when selected by the user. That is, the Status key 718 displays the status field of the service order that indicates whether the order is complete, in progress, incomplete, etc., the Remarks key 722 displays the remarks section, and so forth.

While the present invention has been described with reference to a client-server architecture, as will be appreciated by those of skill in the art, the present invention may be provided as a stand-alone application.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method of correcting an error in a service order, the service order comprising an electronic document having a plurality of fields, the plurality of fields having data associated therewith, the method comprising:
providing a service order control panel, the service order control panel comprising a plurality of function controls, each function control having an associated predetermined function that manipulates data in at least one of the plurality of fields in the service order;
accepting user input from a user to select a function control; and
performing the predetermined function associated with the selected function control to manipulate data to correct the error in at least one of the plurality of fields in the service order.

2. The method of claim 1, wherein the service order control panel further comprises at least one linking control, the linking control having a portion of the service order associated therewith, the method further comprising:
accepting user input to select a linking control; and
displaying the portion of the service order associated with the selected linking control.

3. The method of claim 1, wherein performing the predetermined function further comprises automatically performing the service order.

4. The method of claim 1, further comprising accepting user input from the user to edit data associated with at least one of the plurality of fields.

5. The method of claim 1, wherein the predetermined function comprises a disconnect function and performing the predetermined function further comprises automatically disconnecting a telecommunications service.

6. The method of claim 1, wherein the predetermined function comprises a connect function and performing the predetermined function further comprises automatically connecting a telecommunications service.

7. The method of claim 1, wherein the predetermined function comprises a transfer function and performing the predetermined function further comprises automatically transferring a telecommunications service to a predetermined location.

8. The method of claim 1, wherein the predetermined function comprises a no field work function and performing the predetermined function further comprises changing one of the plurality of fields in the service order to indicate that no field work is required.

9. The method of claim 1, wherein performing the predetermined function further comprises manipulating the data in at least one of the plurality of fields in the service order to indicate that the service order is complete.

10. The method of claim 1, wherein performing the predetermined function further comprises altering data in at least one of the plurality of fields in the service order.

11. The method of claim 10, wherein the data is a date of service.

12. The method of claim 1, wherein the service order is a telecommunications service order.

13. A computer program product for correcting an error in a service order, the service order comprising an electronic document having a plurality of fields, the plurality of fields having data associated therewith, the computer program product comprising:
a computer readable medium having computer readable program code embodied therein, the computer readable program code comprising:
computer readable program code which provides a service order control panel, the service order control panel comprising a plurality of function controls, each function control having an associated predetermined function that manipulates data in at least one of the plurality of fields in the service order;
computer readable program code which accepts user input from a user to select a function control; and
computer readable program code which performs the predetermined function associated with the selected function control to manipulate data to correct the error in at least one of the plurality of fields in the service order.

14. The computer program product of claim 13, wherein the service order control panel further comprises at least one linking control, the linking control having a portion of the service order associated therewith, the computer readable program code further comprising:
computer readable program code which accepts user input to select a linking control; and
computer readable program code which displays the portion of the service order associated with the selected linking control.

15. A system for correcting an error in a service order, the service order comprising an electronic document having a plurality of fields, the plurality of fields having data associated therewith, the system comprising:
means for providing a service order control panel, the service order control panel comprising a plurality of function controls, each function control having an associated predetermined function that manipulates data in at least one of the plurality of fields in the service order;
means for accepting user input from a user to select a function control; and
means for performing the predetermined function associated with the selected function control to manipulate data to correct the error in at least one of the plurality of fields in the service order.

16. The system of claim 15, wherein the service order control panel further comprises at least one linking control, the linking control having a portion of the service order associated therewith, the computer readable program code further comprising:
means for accepting user input to select a linking control; and
means for displaying the portion of the service order associated with the selected linking control.
